(19) United States
(12) Patent Application Publication
(10) Pub. No.: US 2012/0162112 A1
(43) Pub. Date: Jun. 28, 2012

(54) METHOD AND APPARATUS FOR DISPLAYING MENU OF PORTABLE TERMINAL

(75) Inventor: Young Ho CHO, Seoul (KR)

(73) Assignee: SAMSUNG ELECTRONICS CO., LTD., Gyeonggi-Do (KR)

(21) Appl. No.: 13/337,450

(22) Filed: Dec. 27, 2011

(30) Foreign Application Priority Data
Dec. 28, 2010 (KR) 10-2010-0136345

(51) Int. Cl. G06F 3/041

(52) U.S. Cl. 345/173

(57) ABSTRACT

Provided is a method of displaying a menu in a portable terminal having a touch panel. In a mode display screen, a multi touch occurring at least two locations of the mode display screen is detected. When a single drop occurs thereafter at one of the at least two locations, a hidden menu corresponding to one of the other of the at least two locations is determined, then displayed upon detection of a subsequent multi drop at the at least two locations in the mode display screen.

### CLAIM OF PRIORITY

This application claims, pursuant to 35 USC 119, priority to, and the benefit of the earlier filing date of, that patent application filed in the Korean Intellectual Property Office on Dec. 28, 2010 and assigned Serial No. 10-2010-0136345, the contents of which are incorporated herein by reference.

### BACKGROUND OF THE INVENTION

1. Field of the Invention

The present invention relates to a method and an apparatus for driving a portable terminal, and more particularly, to a method and an apparatus for displaying a menu of a portable terminal having a touch panel.

2. Description of the Related Art

Generally, portable terminals have various features to provide complex functions. In order to perform various functions, the portable terminals include an input unit such as a keyboard or a mouse, which hinders portability. To this end, current portable terminals have a touch panel that replaces the keyboard or the mouse.

However, in the conventional portable terminal described above, menu items are typically arranged in a complicated tree structure. Thus, in order to access a particular function, multiple menus need to be displayed successively to select a desired function.

### SUMMARY OF THE INVENTION

The present invention has been made in view of the above problems and provides additional advantages, by providing an improved method of displaying a menu in a portable terminal to enhance user convenience and efficiency in using the portable terminal.

In accordance with an aspect of the present invention, a method for displaying a menu of a portable terminal having a touch panel includes displaying a mode display screen, detecting a multi touch occurring in at least two locations of the mode display screen in response to the mode display screen, the two locations being separated from each other, determining, when a single drop occurs in one of the at least two locations, a hidden menu in response to one of the other two locations in the mode display screen, and displaying the hidden menu on the mode display screen upon detection of a multi drop.

In accordance with another aspect of the present invention, an apparatus for displaying a menu of a portable terminal is provided includes a display unit configured to display a mode display screen when the portable terminal is driven, a touch panel configured to detect a touch for controlling the mode display screen, and a control unit configured to detect a multi touch occurring in at least two locations of the touch panel, configured to determine, when a single drop is detected at one of the two locations, a hidden menu in response to one of the other two locations in the mode display screen, and configured to display the hidden menu on the mode display screen upon detection of a multi drop, wherein the at least two locations are separated from each other.

According to the present invention, a menu for a desired function of the portable terminal can be conveniently provided. Namely, the hidden menu is determined and displayed according to the multi touch, single drop or single touch event in the portable terminal, thereby allowing easy access to a particular function. It is not necessary to display multiple menu items in a consecutive order in order for a user to access to the desired function. Thus, the number of necessary steps required to touch the touch panel to search for the desired function is reduced.

### BRIEF DESCRIPTION OF THE DRAWINGS

The above features and advantages of the present invention will be more apparent from the following detailed description in conjunction with the accompanying drawings, in which:

FIG. 1 is a block diagram illustrating the configuration of a portable terminal according to an exemplary embodiment of the present invention;

FIG. 2 is a flow chart illustrating a menu display procedure in a portable terminal according to an exemplary embodiment of the present invention; and

FIGS. 3 through 7 illustrate example screens displayed when performing a menu display procedure in a portable terminal according to exemplary embodiments of the present invention.

Through the drawings, it should be noted that like reference numbers are used to depict the same or similar elements, features, and structures.

### DETAILED DESCRIPTION OF THE INVENTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. In addition, description of well-known functions and constructions may be omitted for clarity and conciseness.

The terms and words used in the following description and claims are not limited to the bibliographical meanings, but, are merely used by the inventor to enable a clear and consistent understanding of the invention.

It is to be understood that the singular forms “a,” “an,” and “the” include plural referents unless the context clearly dictates otherwise. Thus, for example, reference to “a component surface” includes reference to one or more of such surfaces.

In the following description, the term “driving mode,” as used herein, may refer to a current state of a portable terminal. Here, the driving mode can be, for example, an idle mode or a menu display mode. The term “mode display screen,” as used herein, may refer to a screen corresponding to the driving mode. Here, the mode display screen can be, for example, an idle screen or a menu display screen. In other words, when the driving mode is the idle mode, the portable terminal displays the mode display screen as being the idle screen. Also, when the driving mode is the menu display mode, the portable terminal displays the mode display screen as being the menu display screen. The term “hidden menu,” as used herein, may refer to a menu being determined according to the driving mode of the portable terminal. The hidden menu can be displayed in the driving mode of the portable terminal. In other words, depending on circumstances, the hidden menu can be displayed or hidden in the mode display screen.

In addition, the term “touch,” as used herein, may refer to an operation in which a user of the portable terminal contacts a touch panel. The term “single touch,” as used herein, may refer to an operation in which the user of the portable terminal contacts the touch panel at a single location. The term “multi touch,” as used herein, may refer to an operation in which the user of the portable terminal contacts the touch panel on at least two locations, each being separated from each other. The term “drop,” as used herein, may refer to an operation in which the user of the portable terminal releases the touch on a single position of the touch panel of the portable terminal. The term “single drop,” as used herein, may refer to an operation in which the user of the portable terminal releases the touch on one location of the touch panel. The term “multi drop,” as used herein, may refer to an operation in which the user of the portable terminal releases the touch on the at least two locations of the touch panel. The term “tap,” as used herein, may refer to an operation in which the user of the portable terminal consecutively performs the touch and the drop operations. Here, the term “single tap,” as used herein, may refer to an operation in which the user of the portable terminal performs the touch and the drop operations on one location on the touch panel. The term “drag,” as used herein, may refer to an operation in which the user of the portable terminal moves a touch position on the touch panel.

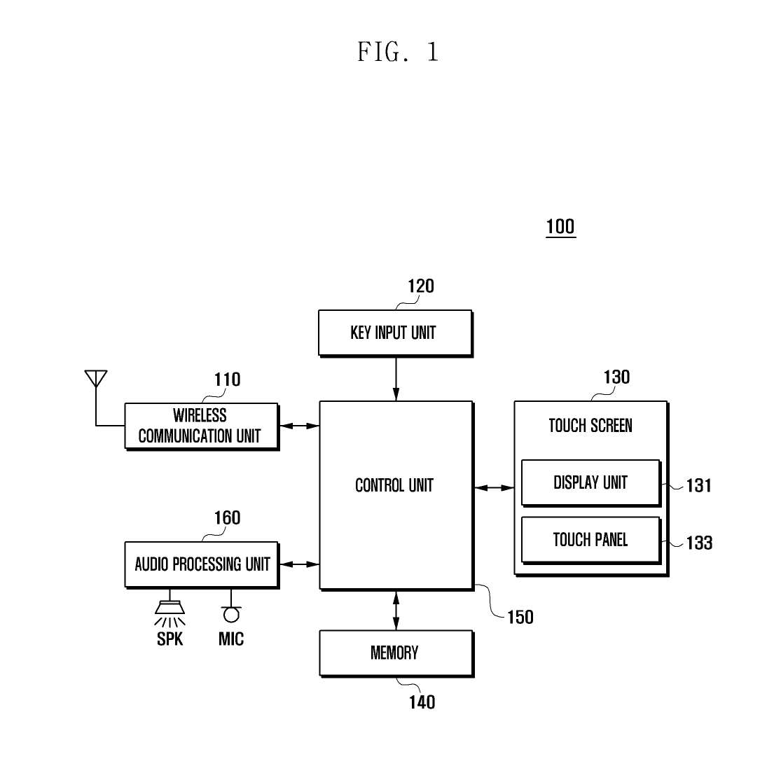

FIG. 1 is a block diagram illustrating the configuration of a portable terminal, such as a mobile phone, according to an exemplary embodiment of the present invention.

Referring to FIG. 1, a portable terminal 100 according to the exemplary embodiment of the present invention includes a wireless communication unit 110, a key input unit 120, a touch screen 130, a memory 140, a control unit 150 and an audio processing unit 160.

The wireless communication unit 110 performs wireless communication of the portable terminal 100. The wireless communication unit 110 includes a radio frequency (RF) transmitter for performing a frequency up-conversion and amplification of a transmission signal, and an RF receiver for performing noise amplification and a frequency down-conversion of a received signal.

The key input unit 120 includes function keys for setting and executing various functions.

The touch screen 130 includes a display unit 131 and a touch panel 133. The display unit 131 displays a state of the portable terminal 100. Here, the display unit 131 is implemented in a liquid crystal display (LCD) and includes an LCD control unit, a memory for storing a display data and an LCD device. The touch panel 133 detects a touch on the display unit 131. The touch panel 133 is mounted on the display unit 131, and includes a touch detection unit (not shown) and a signal conversion unit (not shown). The touch detection unit detects a change in a physical quantity such as, for example, resistance or capacity, to detect generation of the touch. The signal conversion unit converts the change in the physical quantity into a touch signal.

The memory 140 includes a program memory and a data memory. The program memory stores programs for controlling a general operation of the portable terminal 100. The program memory can also store a program for displaying a menu according to an exemplary embodiment of the present invention. The data memory functions to store a data generated during executing the program. Here, the memory 140 can store at least one hidden menu that is mapped to each mode display screen according to one exemplary embodiment of the present invention. Also, the memory 140 can store at least one hidden menu that is mapped to a part area of a particular mode display screen according to one exemplary embodiment of the present invention.

The control unit 150 performs to control an overall operation of the portable terminal 100. The control unit 150 includes a data processing unit, which comprises a transmitter for encoding and modulating a transmission signal and a receiver for decoding and demodulating a received signal. Here, the data processing unit can include a modem and a codec. The codec can include a data code for processing a packet data and an audio codec for processing an audio signal such as, for example, a voice. Also, the control unit 150 can receive the touch signal from the signal conversion unit to detect a touch, a drop or a tap event that occurs in the touch panel 133.

The control unit 150 controls the display unit 131 to display the mode display screen associated with each driving mode. When a multi touch is detected at least two locations of the touch panel 133 and a single drop and a single touch is thereafter detected at one of the at least two locations associated with the multi touch, the control unit 150 determines a hidden menu corresponding to one of the other locations associated with the multi touch in the mode display screen. The hidden menu is previously set corresponding to each driving mode. Further, the hidden menu is determined corresponding to current driving mode when the control unit detects the multi drop at all locations associated with initial multi drop. Also, when a multi drop is detected on the touch panel 133 at the locations associated with the multi touch, the control unit 150 controls the display unit 131 to display the hidden menu on the mode display screen. Here, the control unit 150 can display the hidden menu on a part area of the mode display screen through the display unit 131 in a drop down or pop-up manner according to an exemplary embodiment of the present invention. Also, when a single tap on the hidden menu is detected through the display panel 133, the control unit 150 executes the hidden menu according to an exemplary embodiment of the present invention.

The audio processing unit 160 reproduces a received audio signal outputted to the audio codec of the data processing unit through a speaker SPK or transmits a transmission audio signal generated from a microphone MIC to the audio codec of the data processing unit.

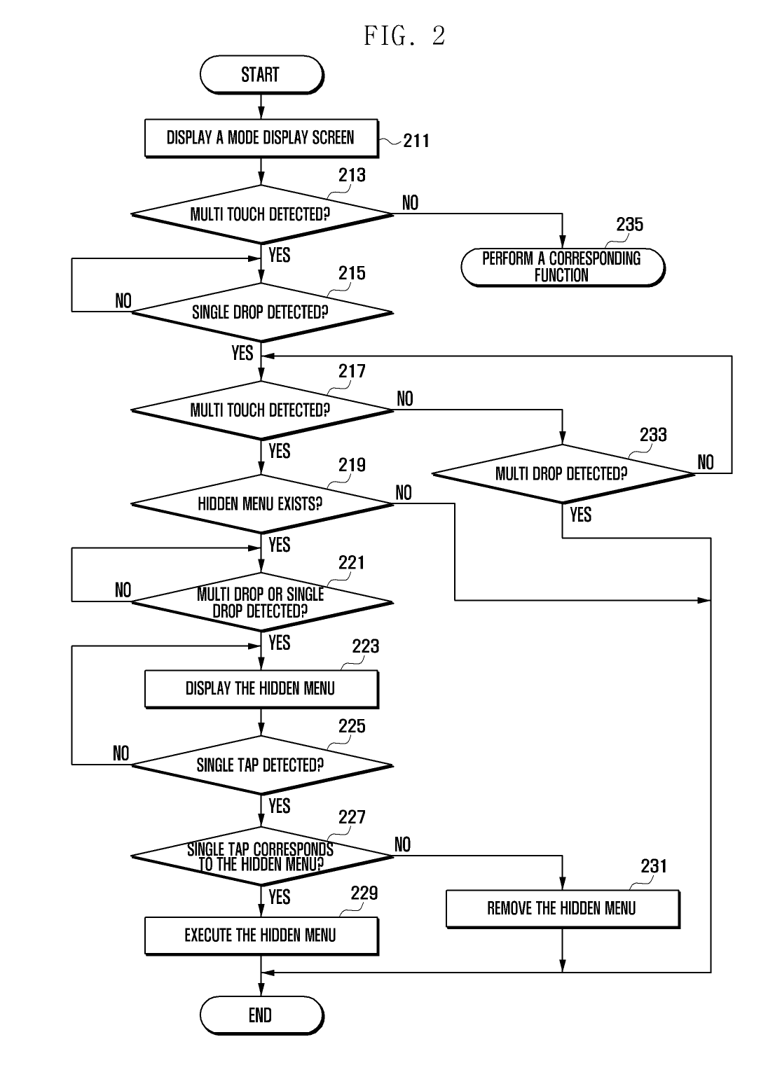

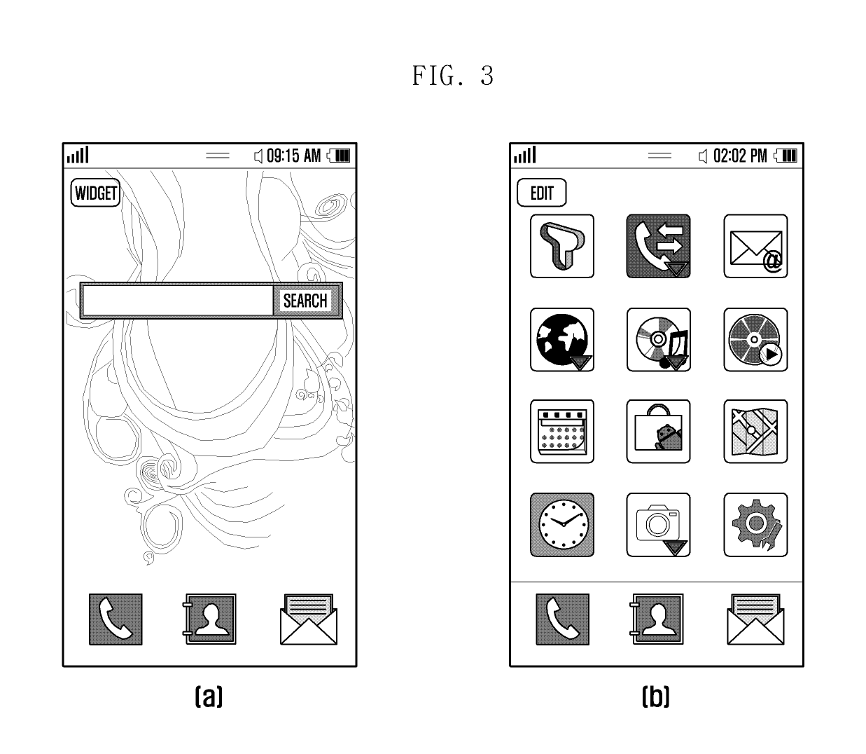

FIG. 2 is a flow chart illustrating a menu display process in a portable terminal according to an exemplary embodiment of the present invention. FIGS. 3 through 7 illustrate example screens displayed when performing a menu display process in a portable terminal according to exemplary embodiments of the present invention. In FIGS. 3 through 7, (a) describes a case in which the driving mode is an idle mode and (b) describes a case in which the driving mode is a menu display mode.

Referring to FIG. 2, a menu display process of the portable terminal 100 according to an exemplary embodiment of the present invention starts at a step where a mode display screen, either an idle or menu display mode, is displayed on the display unit 131 by a control unit 150 (211), as shown in FIG. 3. In other words, the control unit 150 can display an idle screen showing a predetermined background image, as shown in (a) of FIG. 3. Additionally, the control unit 150 can further display an executable menu items in an icon format on the background image of the idle screen.

Alternatively, as shown in (b) of FIG. 3, the control unit 150 can display the menu display screen. Here, the control unit 150 can present multiple menu items in a list or icon style. In addition, when the hidden menu previously set corresponding to the menu item exists, the control unit 150 can add an image indicating the presence of the hidden menu to a corresponding menu icon to be displayed.

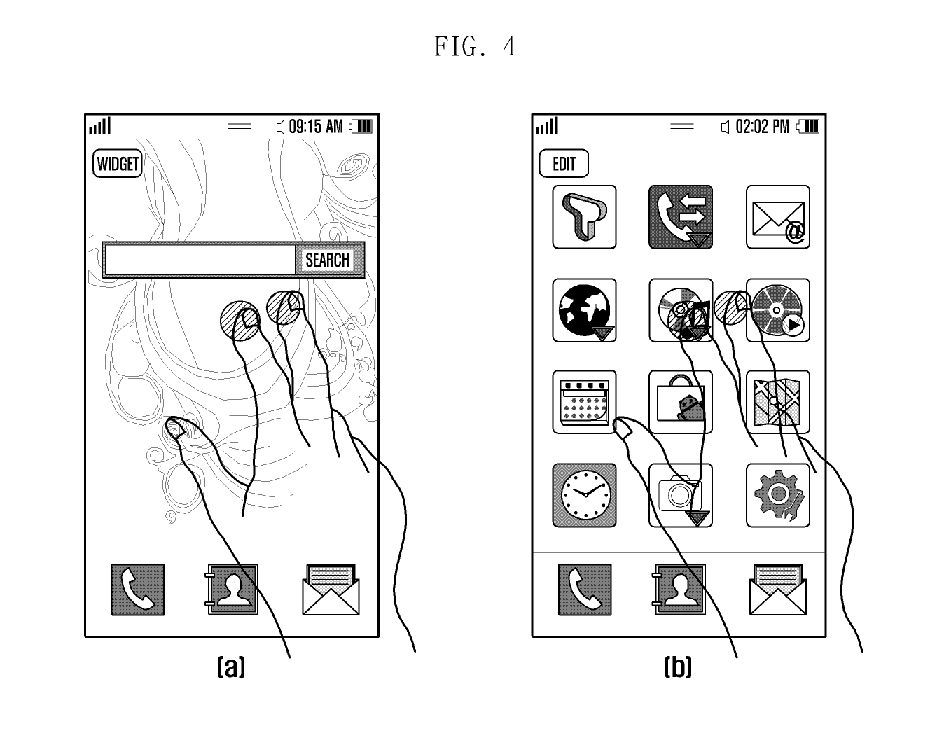

Next, when the mode display screen is displayed at step 211 and the multi touch is generated at two locations, separated from each other, on the touch panel 133, the control unit 150 detects such event (213). Here, as shown in FIG. 4, when two single touches are generated at different locations at a certain time point, the control unit 150 detects this as the multi touch. Here, the control unit 150 can detect the multi touch corresponding to the background image of the idle screen, as shown in (a) of FIG. 4. Also, the control unit 150 can detect the multi touch corresponding to a particular menu icon, as shown in (b) of FIG. 4. When two single touches are successively detected, the control unit 150 can detect this type activation as the multi touch. The two single touches can occur in sequence or at the same time. Namely, the control unit 150 can detect the multi touch when the single touch is detected at a particular location of the touch panel 133 and another single touch is detected at a different location within a predetermined time period. Note that two single touches can occur in sequence or at the same time.

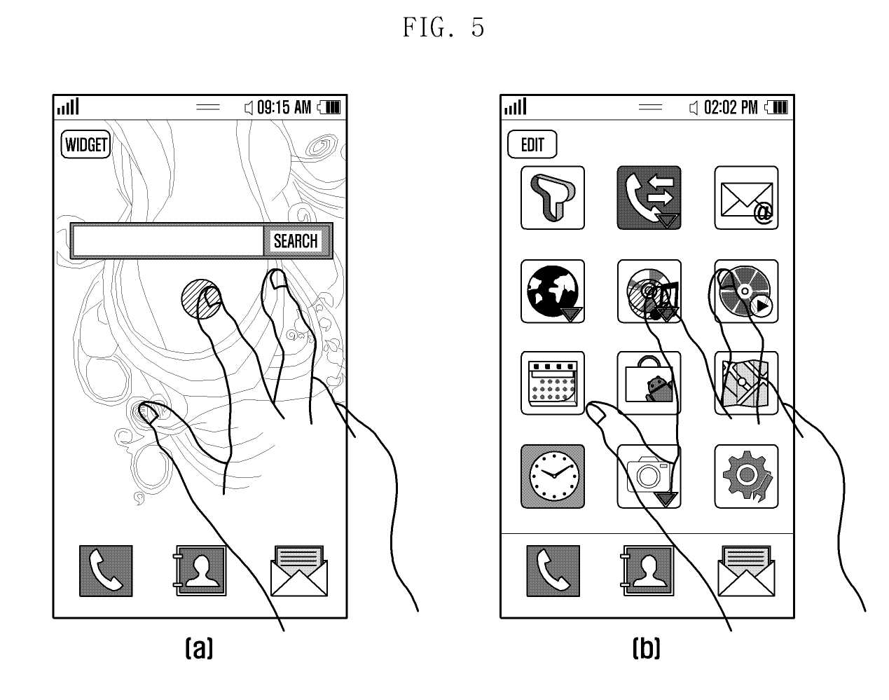

Next, when the multi touch is detected at step 213 and the single drop occurs at one of locations associated with the multi touch of the touch panel 133, the control unit 150 detects such event (215). Here, as shown in FIG. 5, the control unit 150 detects when the single touch is maintained at one of the locations associated with the multi touch and the single drop occurs in one of the other locations. Here, as shown in (a) of FIG. 5, the control unit 150 can detect the single drop corresponding to the background image of the idle screen. Alternatively, as shown in (b) of FIG. 5, the control unit 150 can detect the single drop corresponding to a particular menu icon. Among the locations associated with the multi touch, the control unit 150 can classify and determine a main location and a sub location. Here, the control unit 150 can define the main location as one of the locations associated with the multi touch in which the single touch is maintained and define the sub location as one of the other locations in which the single drop is detected.

Meanwhile, when the mode display screen is displayed at step 211 and the multi touch is not detected at step 213, the control unit 150 can perform a corresponding function (235). Namely, the control unit 150 can perform a predefined function corresponding to at least one or any combination of touch, tap, drag and drop events. Here, if a menu item exists at the particular location, the control unit 150 can perform the menu item.

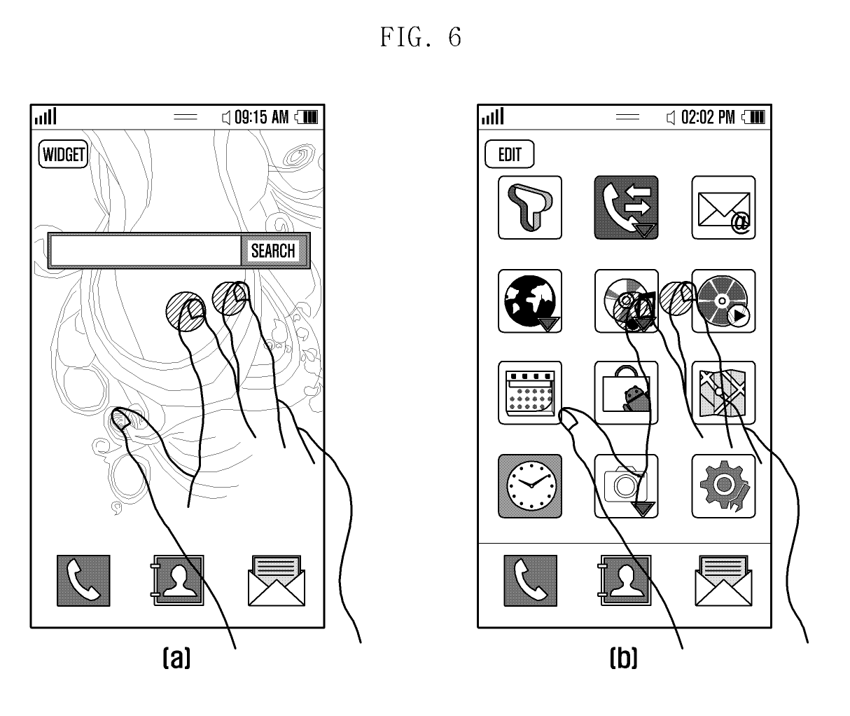

After detecting the single drop at step 215, when the multi touch is generated at two locations, separated from each other, on the touch panel 133, the control unit 150 detects such event (217). Here, as shown in FIG. 6, the control unit 150 detects the multi touch when, while the single touch is maintained, another single touch occurs. If the single touch is maintained, the another single touch can occur anywhere. That is, another single touch can occur at the same location or another location. Here, as shown in (a) of FIG. 6, the control unit 150 can detect the multi touch corresponding to the background image of the idle screen. Alternatively, as shown in (b) of FIG. 6, the control unit 150 can detect the multi touch corresponding to a particular menu icon.

Thereafter, the control unit 150 determines whether there exists the hidden menu that is displayable, based on the driving mode (219). In this case, the control unit 150 determines the hidden menu corresponding to the main location of the mode display screen. Here, the hidden menu can include an attribute menu for setting an attribute in the idle mode. Alternatively, the hidden menu can include a sub menu of a menu item corresponding to an icon at the main location in the menu display screen. This sentence merely discloses examples of the hidden menu. That is, the hidden menu is not limited as the attribute menu or the sub menu.

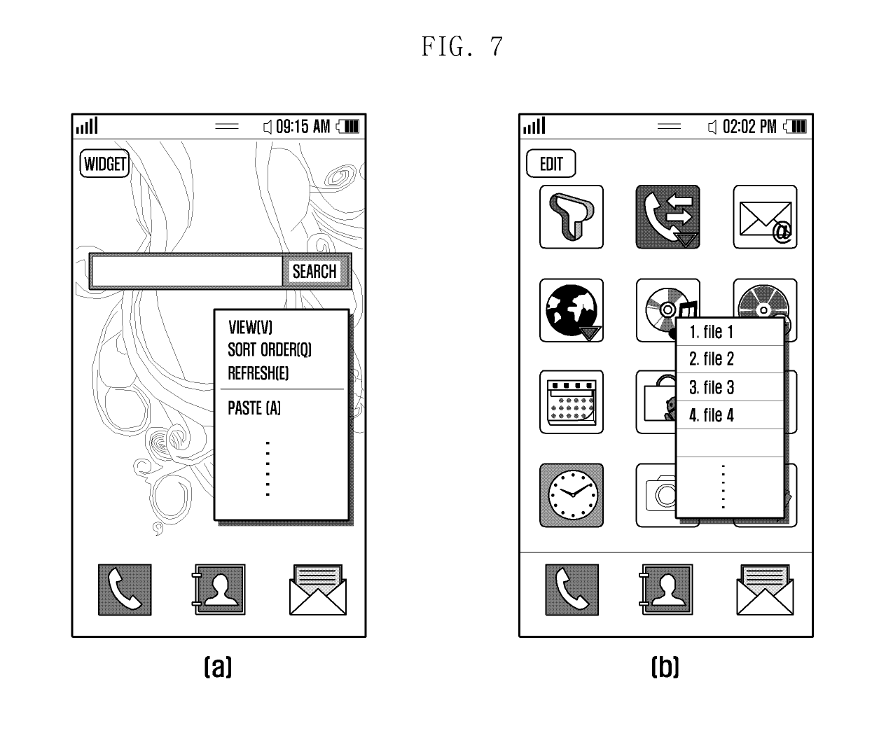

Next, when the hidden menu is determined to exist at step 219 and the multi drop or the single drop occurs at the locations associated with the multi touch on the touch panel 133, the control unit 150 detects such event (221). In this case, when two single drops are successively detected at the locations associated with the multi touch, the control unit 150 can consider such event as the multi drop. Namely, when the single drop is detected at one of the locations associated with the multi touch on the touch panel 133 and another single drop occurs in one of the other locations, the control unit 150 can detect such event as the multi drop. Alternatively, when the single touch is maintained at the main location and the single drop occurs at the sub location, the control unit 150 can consider such event as the single drop. Next, the control unit 150 displays the hidden menu on the mode display screen of the display unit 131 (223). Here, the control unit 150 displays the hidden menu according to the driving mode, as shown in FIG. 7. Here, the control unit 150 can display the hidden menu on a part area of the mode display screen through the display unit 131 in the drop down or pop-up manner. Namely, as shown in (a) of FIG. 7, the control unit 150 can display the attribute menu with the background image on the idle screen. Alternatively, as shown in (b) of FIG. 7, the control unit can display a sub menu associated with the menu icon at the sub location along with other menu icons on the menu display screen.

While displaying the hidden menu at step 223, when the single tap occurs at a particular location of the touch panel 133, the control unit 150 detects such event (225). Next, the control unit 150 determines whether the particular location in which the single tap occurs corresponds to the hidden menu (227). When it is determined that the location associated with the single tap corresponds to the hidden menu at step 227, the control unit 150 executes the hidden menu and terminates the menu display procedure (229). Here, the control unit 150 can set or modify the attribute of the idle mode. Alternatively, the control unit 150 can execute the sub menu of the menu item corresponding to the icon at the main location.

Meanwhile, when it is determined that the location associated with the single tap does not correspond to the hidden menu at step 227, the control unit 150 removes the hidden menu from the mode display screen of the display unit 131 and terminates the menu display procedure (231). Namely, when the single tap is detected in the background image of the idle screen, the control unit 150 can remove the attribute menu from the idle screen. Alternatively, when the single tap is detected in the icons or in a space between the icons of the menu display screen, the control unit 150 can remove the submenu from the menu display screen.

When the multi touch is detected at step 217 and the hidden menu is determined not to exist at step 219, the control unit 150 terminates the menu display procedure. Alternatively, when the multi touch is not detected at step 217 and the multi drop occurs at the locations associated with the multi touch on the touch panel 133, the control unit 150 detects such event (233). Namely, when the single drop is detected at one of the locations associated with the multi touch at step 215 and another single drop is detected at one of the other locations associated with the multi touch at step 233, the control unit 150 can consider such event as the multi drop. Then, the control unit 150 terminates the menu display procedure.

In the above embodiment, it is described that the main location and the sub location are determined in a circumstance where the multi touch is detected at different locations that are separated from each other in the touch panel of the portable terminal and the single drop is thereafter detected at one of the locations associated with the multi touch. However, it should be noted that the present invention is not limited to this example. In other words, the present invention can be implemented by determining the main location and the sub location according to predefined criteria between the locations associated with the multi touch in the portable terminal. To this end, the portable terminal can determine and store whether a user is left handed or right handed beforehand according to another exemplary embodiment of the present invention. Also, the portable terminal can further include an acceleration sensor according to another exemplary embodiment of the present invention. Here, the acceleration sensor measures positioning of the portable terminal, e.g., an orientation or an angle from the horizontal. Here, it is assumed that the touch panel has an X axis and a Y axis.

According to another exemplary embodiment of the present invention, when the multi touch is detected at different locations that are separated from each other in the touch panel while displaying the mode display screen, the portable terminal detects coordinates of the locations associated with the multi touch. Here, the portable terminal can determine the coordinates of the locations of the multi touch as (x₁, y₁) and (x₂, y₂), respectively. Also, the portable terminal determines one of the X axis and the Y axis of the touch panel that is vertically directed. Further, the portable terminal determines whether the user is set as being left handed or right handed. The portable terminal determines which handuser according to information preset by the user. Next, the portable terminal compares the coordinates of the locations associated with the multi touch to determine the main location and the sub location.

In other words, when it is determined that the Y axis of the touch panel is vertically directed and the user is set as left handed, the portable terminal determines a position corresponding to x coordinate of greater value among x₁ and x₂ as the main location. When it is determined that the Y axis of the touch panel is directed upward to the sky and the user is set as right handed, the portable terminal determines a position corresponding to x coordinate of smaller value among x₁ and x₂ as the main location.

When it is determined that the X axis of the touch panel is directed upward to the sky and the user is set as left handed, the portable terminal determines as the main location a position whose y coordinate value is greater between y₁ and y₂. When it is determined that the X axis of the touch panel is directed upward to the sky and the user is set as right handed, the portable terminal determines as the main location a position whose y coordinate value is smaller between y₁ and y₂. It should be noted that the directions in which the X axis and the Y axis extend depend on how design choices define the orientation of the touch panel. Therefore, comparison result between the coordinate values on the X or Y axis for determining the main and sub locations can vary depending on the direction of the X axis or the Y axis.

According to the present invention, a menu for a desired function of the portable terminal can be conveniently provided. Namely, the hidden menu is determined and displayed according to the multi touch, single drop or single touch event in the portable terminal, thereby allowing easy access to a particular function. In other words, it is not necessary to display multiple menu items in a consecutive order in order for a user to access to the particular function of the portable terminal. Thus, the number of necessary steps required to touch the touch panel to search for a user's desired function is reduced. Accordingly, user convenience in using the portable terminal can be improved while enhancing use efficiency of the portable terminal.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a controller that may be a general purpose computer, a special processor, a programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. As would be recognized by those skilled in the art, when a general purpose computer is loaded with, or accesses, software or code for implementing the processing shown herein, the general purpose computer is transformed into a special purpose computer that may at least perform the processing shown herein.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A method of displaying a menu in a portable terminal having a touch panel, the method comprising:
displaying a mode display screen;
detecting a first multi touch occurring in at least two locations on the mode display screen;
determining a hidden menu in the mode display screen when a single drop occurs in the detected multi touch; and
displaying the hidden menu on the mode display screen upon detection of a second multi drop.

2. The method according to claim 1, wherein the mode display screen is an idle screen corresponding to an idle mode, and the hidden menu includes an attribute menu for setting an attribute in the idle mode.

3. The method according to claim 1, wherein the mode display screen displays menu items and the hidden menu includes at least one sub menu corresponding to one of the menu items in the menu display screen.

4. The method according to claim 3, wherein displaying a mode display screen comprises:
displaying the menu item as an icon; and
displaying, when the menu item has the hidden menu, an image indicating a presence of the hidden menu after adding the image to the icon.

5. The method according to claim 1, further comprising:
executing the hidden menu when a single tap is detected on the hidden menu.

6. The method according to claim 5, wherein displaying the hidden menu comprises:
displaying the hidden menu in a part area of the mode display screen in a drop down manner or a pop-up manner.

7. The method according to claim 6, further comprising:
removing the hidden menu from the mode display screen when a touch is detected in other area than the mode display screen.

8. The method according to claim 1, further comprising determining whether the first multi touch is performed by a left hand or a right handed user.

9. An apparatus for displaying a menu in a portable terminal, comprising:
a display unit configured to display a mode display screen;
a touch panel configured to detect a touch for controlling the mode display screen; and
a control unit configured to detect a first multi touch occurring in at least two locations of the touch panel, configured to determine a hidden menu when a single drop is detected at one of the at least two locations, and configured to display the hidden menu on the mode display screen upon detection of a second multi drop.

10. The apparatus according to claim 9, wherein the mode display screen is an idle screen corresponding to an idle mode, and the hidden menu includes a attribute menu for setting a attribute in the idle mode.

11. The apparatus according to claim 9, wherein the mode display screen displays menu items and the hidden menu includes at least one sub menu corresponding to one of the menu items in the menu display screen.

12. The apparatus according to claim 11, wherein the control unit configured to display the menu item as an icon and configured to display, when the menu item has the hidden menu, an image indicating a presence of the hidden menu.

13. The apparatus according to claim 9, wherein the control unit is configured to execute the hidden menu when a single tap is detected on the hidden menu.

14. The apparatus according to claim 13, wherein the control unit is configured to display the hidden menu in a part area of the mode display screen in a drop down manner or a pop-up manner.

15. The apparatus according to claim 14, wherein the control unit is configured to remove the hidden menu from the mode display screen when the touch is detected in other area than the mode display screen.

16. The apparatus according to claim 9, wherein the control unit is configured to determine whether the first multi touch is performed by a left hand or a right handed user.
